(19) United States
(12) Patent Application Publication
(10) Pub. No.: US 2013/0206819 A1
(43) Pub. Date: Aug. 15, 2013

(54) PROCESS FOR CONNECTING TWO AIRCRAFT FUSELAGE SEGMENTS BY MEANS OF FRICTION TWIST WELDING

(71) Applicant: AIRBUS OPERATIONS GMBH, Hamburg (DE)

(72) Inventors: Juergen SILVANUS, Munich (DE); Marco PACCHIONE, Hamburg (DE); Stefan ELZE, Bremen (DE)

(73) Assignee: AIRBUS OPERATIONS GMBH, Hamburg (DE)

(21) Appl. No.: 13/745,234

(22) Filed: Jan. 18, 2013

Related U.S. Application Data
(63) Continuation of application No. PCT/EP2011/062690, filed on Jul. 22, 2011.

(30) Foreign Application Priority Data
Jul. 27, 2010 (DE) 10 2010 032 402.7

(51) Int. Cl. B23K 20/12

(52) U.S. Cl. CPC B23K 20/129
USPC 228/114

(57) ABSTRACT

A process for connecting two aircraft fuselage segments and a reinforcing profile arranged in the joint region of the two aircraft fuselage segments by friction twist welding using a rotating tool, wherein a cover plate is brought onto the aircraft fuselage segments to be connected above the joint regions and after the friction twist welding the remainder of the cover plate is milled off. This makes it possible to overcome significantly greater gap tolerances in the edges to be connected so that the dimension tolerance requirements for the aircraft fuselage segments can be reduced. Furthermore, a smooth surface can be achieved in the welding region.

### CROSS-REFERENCE TO RELATED APPLICATIONS

This application is a continuation of and claims priority to PCT/EP2011/062690 filed Jul. 22, 2011 which claims the benefit of and priority to German Patent Application No. 10 2010 032 402.7 filed Jul. 27, 2010, the entire disclosures of which are herein incorporated by reference.

### FIELD OF THE INVENTION

The invention relates to a method for connecting two aircraft fuselage segments and a reinforcing profile arranged in the joint region of the two aircraft fuselage segments by friction twist welding using a rotating tool.

### BACKGROUND OF THE INVENTION

In the construction of aircraft in particular, the tolerance requirements of the fuselage segments to be connected have not generally previously permitted any butt-joint welding by means of friction twist welding, because the gaps to be expected only permit a process to be carried out with costly additional measures. The welded interconnection of large components curved in one dimension (i.e. barrel-shaped) requires a tensioning process, in which a substantial part of the tensioning components are inside the components and have to be removed at considerable cost after welding.

Joining connections between aircraft fuselage segments are therefore conventionally carried out in the lap joint, in particular via a lap rivet connection, in which the plurality of rows of rivets are arranged side by side.

If a reinforcing profile (for example a stringer) is fitted, this component is additionally connected to one or more rows of rivets.

A generic method is known from DE 10 2008 025 872 A1, in which the aircraft fuselage segments are interconnected by means of friction twist welding. A reinforcing profile/stringer can additionally be welded during the welding process, said reinforcing profile acting as a thrust bearing against the compression force generated by the rotating tool.

The disadvantage of this conventional method is that the components have to be manufactured relatively precisely, as the gap tolerances cannot be greater that approx. 50% of the component thickness (approx. 1.3 mm) in order to meet the high welding quality requirements. A further disadvantage is that the surface is irregular or rough after the welding process and thus the requirements for a smooth outer skin of the formed aircraft can only be met with increased outlay.

Friction twist welding methods which make use of cover plates are known per se from JP 2004261895 A or EP 1 790 425 A1, but the end surfaces are uneven once the welding process is complete, with the result that the application in the connection of aircraft fuselage segments leads to undesirable flow phenomena at these joint regions.

### SUMMARY OF THE INVENTION

On this basis, one idea of the invention is to prevent the aforementioned disadvantages and to specify a method for connecting two aircraft fuselage segments, which method can be carried out with a reduced production outlay in terms of the dimensional tolerances and permits a connection with a smooth outer contour of the weld seam.

In particular, the invention proposes to place a cover plate above the joint regions on the aircraft fuselage segments to be connected, the region of the cover plate being milled smooth after the friction twist welding.

This advantageously makes is possible for significantly greater gap tolerances to be overcome without the weld seam quality being affected. Gap widths in the region of 2 mm (in workpieces approx. 3 mm thick) can be bridged. The dimensional tolerance requirements of the aircraft fuselage segments can thus be reduced. The remains of the cover plate are removed by the subsequent milling process and a smooth surface can be achieved in the welded region. Furthermore, in comparison to some conventional friction twist welding methods, a potential for weight reduction and improved strength properties emerge.

According to an advantageous development of the invention, the cover plate has a thickness which is greater than the diameter of the tool, with the result that marginal strips of the cover plate remain on either side of the tool during friction twist welding. These remaining marginal strips are milled out in the subsequent milling process. In this way, it is ensured that no undesirable deformations form on the edges of the cover plate so that a smooth contour is achieved after the milling process.

According to an advantageous development of the invention, a cover plate is used with a wall thickness which corresponds approximately to the depth of the fuselage segments to be connected, i.e. approximately 3 mm to 5 mm. On the one hand, at this wall thickness sufficient material is pressed into the gap between the joint regions to achieve a sufficient connection of the two joint regions, and on the other hand material remains above the surface of the actual aircraft fuselage segment and can be removed in the subsequent milling process.

According to an advantageous development of the invention, the machining process is repeated at least once with the tool. This development has the advantage that the entire joining process can be divided between two welding processes, with the result that larger gap widths can be bridged as the amount of the filling material transported from the cover plate in the gap is increased and this gap is already filled in part after the first welding process.

According to a further advantageous development of the invention, a cover plate is used which comprises a material strip in the centre, which material strip is pressed into the gap between the joint regions during the welding process. In this case, the amount of material required to fill the gaps is supplied by the material strips integrally formed on the cover plate. The cover plate thus functions less as a provider of material and more for positioning the material strips in the gap. As a result, the tool is not required to take on an additional gap-filling role, with the result that welding processes are possible at a lower immersion depth.

### BRIEF DESCRIPTION OF THE DRAWINGS

The invention will be described hereinafter with reference to the accompanying drawings, in which:

FIG. 1 shows a schematic perspective view of a first process step of the connection process;

FIG. 2 shows a schematic perspective view of a second process step of the connection process;

FIG. 3 shows a schematic perspective view of the product of the method.

### DETAILED DESCRIPTION OF THE INVENTION

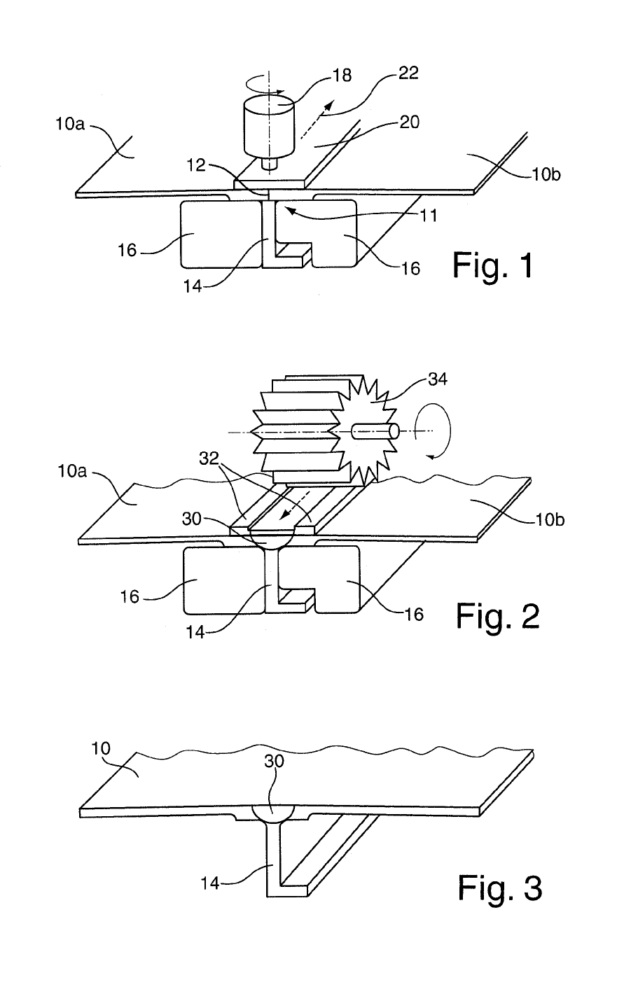

In FIG. 1, two aircraft fuselage segments 10a, 10b are shown in a schematic perspective view, which aircraft fuselage segments comprise two joint regions 11 to be interconnected and meet via these joint regions except for a remaining gap 12.

A reinforcing profile 14, for example a stringer, is arranged on one side of this gap 12, the connection side of said reinforcing profile lying directly against the region of the gap 12 between the two aircraft fuselage segments 10a, 10b. Two support members 16 are further provided on each side of the reinforcing profile 14 and serve as a thrust bearing for a tool 18 and also guide and fix the reinforcing profile 14 during the welding process.

Opposite the reinforcing profile 14, the gap 12 is covered by a cover plate 20 which is arranged centrally above the gap 12. In order to carry out the friction twist welding process, the tool 18 rotates (with a rotational speed of approximately 500-2000 1/min) and is pressed with considerable force in the region of 10 kN or more against the cover plate 20 by means of a device (not shown), this cover plate 20 being warmed and plastically deformed and the material thereof being pressed in part into the gap 12. The tool 18 is simultaneously moved along the extension of the gap 12 in the direction marked 22, preferably at a speed of approximately 500-4000 mm/min. When the welding process is complete, in other words the tool 18 has travelled along the entire length of the gap 12, a second welding process can take place, in other words the tool 18 can be moved either in the same direction or in the opposite direction, with the same or opposite direction of rotation.

In FIG. 2, like parts are denoted with the same reference numerals as in FIG. 1. FIG. 2 shows a second processing step, the region plasticised during the welding process being indicated by the reference numeral 30. Only two marginal strips 32 of the cover plate 20 (FIG. 1) remain, while the central region is pressed into the gap 12 by the tool 18. A machining procedure follows by means of a miller 34, in which the two marginal strips 32 and the region of the weld seam 30 extending over the surface of the two aircraft fuselage segments 10a, 10b are milled out.

FIG. 3 shows the result of the process once the milling process is complete, wherein only one integral aircraft fuselage segment 10 is provided, having a smooth milled welding region 30, the reinforcing profile 14 now being an integral component of the aircraft fuselage segment 10. The milled welding region 30 can of course subsequently be polished up in order to further improve the quality of the surface.

Advantageously, both the aircraft fuselage segments 10a, 10b and the cover plate 20 consist of the same material, usually an aluminium alloy used in the aviation industry, for example the alloy EN AW-2024, which is frequently used in the field of aviation and aerospace.

We claim:

1. A method for connecting two aircraft fuselage segments and a reinforcing profile arranged in the joint region of the two aircraft fuselage segments by friction twist welding using a rotating tool, characterised in that a cover plate is brought onto the aircraft fuselage segments to be connected above the joint regions and, after the friction twist welding process, the remainder of the cover plate is milled off.

2. The method according to claim 1, characterised in that the cover plate has a width which is greater than the effective diameter of the tool, with the result that marginal strips of the cover plate remain on either side of the tool during friction twist welding.

3. The method according to claim 1, wherein a cover plate is used with a wall thickness which corresponds approximately to the wall thickness of the components to be connected.

4. The method according to claim 3, wherein a cover plate with a wall thickness of 3 mm to 5 mm is used.

5. The method according to claim 1, wherein the machining process is repeated at least once with the tool.

6. The method according to claim 1, wherein a cover plate is used which comprises an integrally formed material strip in the centre, which material strip is pressed into the gap between the joint regions during the welding process.
